(19) United States
(12) Patent Application Publication
(10) Pub. No.: US 2024/0147417 A1
(43) Pub. Date: May 2, 2024

(54) DYNAMIC MECHANISM TO IMPROVE SUBSCRIBER LEVEL PAGING SUCCESS RATE IN LONG TERM EVOLUTION AND NEW RADIO NETWORKS

(71) Applicant: T-MOBILE INNOVATIONS LLC, Overland Park, KS (US)

(72) Inventors: Roopesh Kumar Polaganga, Bothell, WA (US); Vishnukanth Subramaniyam, Naperville, IL (US); Deepak Nadh Tammana, Bothell, WA (US)

(21) Appl. No.: 17/978,866

(22) Filed: Nov. 1, 2022

(51) Int. Cl. H04W 68/02; H04W 8/20

(52) U.S. Cl. CPC H04W 68/02; H04W 8/20

(57) ABSTRACT

Aspects provided herein provide methods, systems, and a non-transitory computer storage media storing computer-useable instructions for dynamically adjusting paging settings in a network. The method begins with determining a first page success rate for a device on the network. The first page success rate for the device is then compared with a predetermined paging threshold. The device may be categorized into a subscriber profile identifier if the first page success rate for the device is less than the predetermined paging threshold. Based on the subscriber profile identifier, at least one of an aggregation level or a number of pages per second is adjusted.

### BACKGROUND

In a mobile communications network such as a long term evolution (LTE) network or new radio (NR) or 5G network, the paging operation is used to indicate the subscriber's position in order to establish a connection with another user. Paging is the only way for the network to notify user equipments (UEs) that are in idle mode about incoming calls or sessions. Blanket paging, currently used, incurs a significant cost in radio bandwidth utilization and adversely affects UE battery life. Device paging in mobile networks uses an aggregation level to determine a number of paging attempts. This aggregation level is static for all UEs and can adversely affect paging success by increasing connection time and network congestion.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for dynamically adjusting paging settings in a network is provided. The method begins with determining a first page success rate for a device on the network. The first page success rate is then compared with a predetermined network paging threshold. The device is categorized into a subscriber profile identifier if the first page success rate for the device is less than the predetermined paging threshold. Based on the subscriber profile identifier, at least one of an aggregation level or a number of pages per second for the device is adjusted.

In a further embodiment, a method for dynamically adjusting paging settings in a network is provided. A paging success threshold is first determined for a tracking area of the network. A first paging success rate for a device on the network is then compared with the paging success threshold. Based on the comparison an aggregation level of the physical downlink control channel (PDCCH) is increased if the first paging success rate for the device is less than the paging success threshold.

An additional embodiment provides a non-transitory computer storage media storing computer-useable instructions that, when executed by one or more processors cause the processors to determine a first page success rate for a device on the network. The processors then compare the first page success rate for the device with a predetermined paging threshold for a tracking area of the network. The device may be categorized into a subscriber profile identifier if the first page success rate for the device is less than the predetermined paging threshold. Based on the subscriber profile identifier, at least one of an aggregation level or a number of pages per second is adjusted.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a diagram of an exemplary network environment incorporating subscriber level paging, in which implementations of the present disclosure may be employed, in accordance with aspects herein;

FIG. 4 is a diagram of paging call flow, in which implementations of the present disclosure may be employed, in accordance with aspects herein;

FIG. 5 is a flow diagram of an exemplary method for dynamic adjustment of paging aggregation level, in which aspects of the present disclosure may be employed, in accordance with aspects herein; and

FIG. 6 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., nodes, cell sites, cell towers) to provide network coverage. The base stations are employed to broadcast and transmit transmissions to user devices of the telecommunications network. An base station may be considered to be a portion of a base station that may comprise an antenna, a radio, and/or a controller. In aspects, a base station is defined by its ability to communicate with a user equipment (UE), such as a wireless communication device (WCD), according to a single protocol (e.g., 3G, 4G, LTE, 5G, or 6G, and the like); however, in other aspects, a single base station may communicate with a UE according to multiple protocols. As used herein, a base station may comprise one base station or more than one base station. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

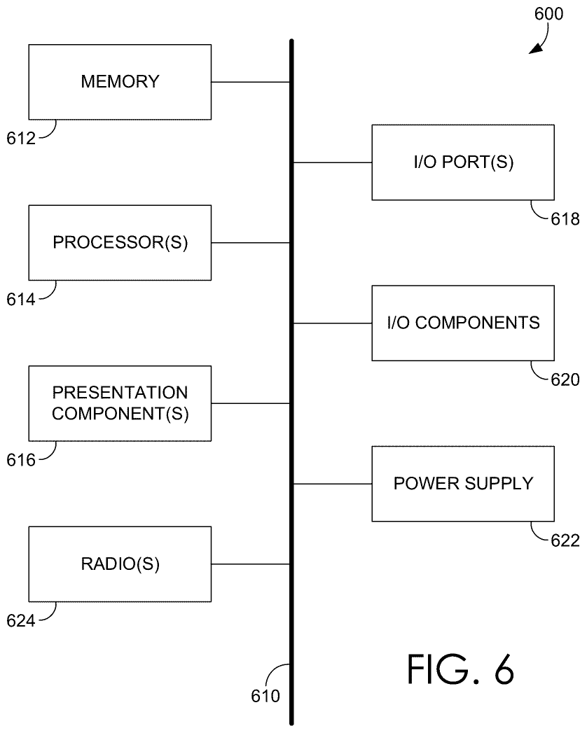

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 600 described herein with respect to FIG. 6.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station.

In aspects, a UE provides UE data including location and channel quality information to the wireless communication network via the base station. Location information may be based on a current or last known position utilizing GPS or other satellite location services, terrestrial triangulation, an base station's physical location, or any other means of obtaining coarse or fine location information. Channel quality information may indicate a realized uplink and/or downlink transmission data rate, observed signal-to-interference-plus-noise ratio (SINR) and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the base station or at the individual antenna array of the base station. In other aspects, the processing of said information may be done remotely.

A service state of the UEs may include, for example, an in-service state when a UE is in-network (i.e., using services of a primary provider to which the UE is subscribed to, otherwise referred to as a home network carrier), or when the UE is roaming (i.e., using services of a secondary provider providing coverage to the particular geographic location of the UE that has agreements in place with the primary provider of the UE). The service state of the UE may also include, for example, an emergency only state when the UE is out-of-network and there are no agreements in place between the primary provider of the UE and the secondary provider providing coverage to the current geographic location of the UE. Finally, the service state of the UE may also include, for example, an out of service state when there are no service providers at the particular geographic location of the UE.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

In accordance with a first aspect of the present disclosure a method for dynamically adjusting paging settings in a network is provided. A first paging success rate is determined for a device on the network. This first paging success rate for the device is then compared with a predetermined paging threshold. The device is categorized into a subscriber profile identifier if the first page success rate for the device is less than the predetermined paging threshold. Based on the subscriber profile identifier at least one of an aggregation level or a number of pages per second is adjusted on the device.

A second aspect of the present disclosure provides a method for dynamically adjusting paging settings in a network. The method begins with determining a paging success rate for a tracking area of the network. A first paging success rate for a device on the network is then compared with the paging success threshold. Based on the comparison, an aggregation level of the physical downlink control channel (PDCCH) of the device is increased if the first paging success rate for the device is less than the paging success threshold.

Another aspect of the present disclosure is directed to a non-transitory computer storage media storing computer-useable instructions that, when used by one or more processors, cause the processors to determine a first page success rate for a device on the network. The first page success rate for the device is then compared with a predetermined paging threshold for a tracking area of the network. The processors then categorize the device into a subscriber profile identifier if the first page success rate for the device is less than the predetermined paging threshold. Based on the subscriber profile identifier, at least one of an aggregation level of a number of pages per second in adjusted.

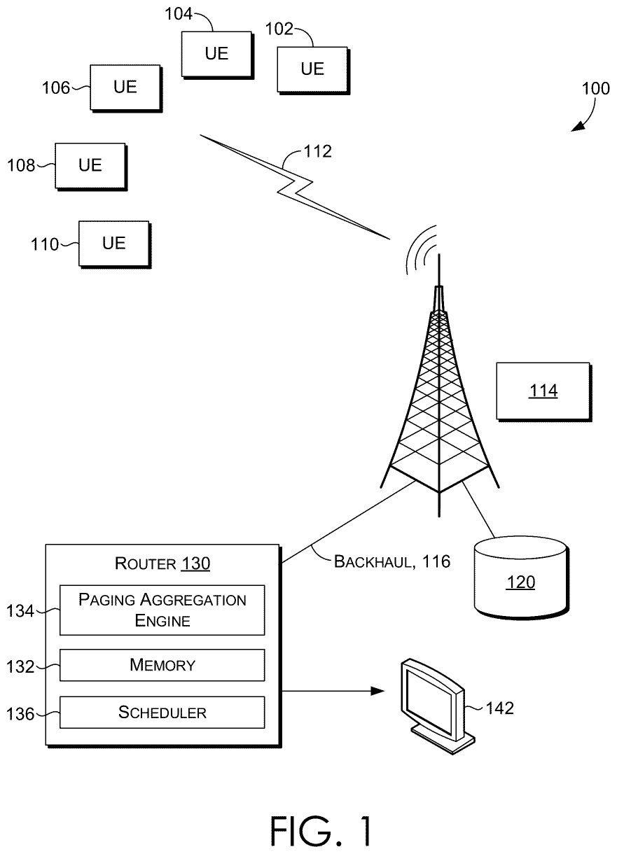

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user equipment (UE) devices 102, 104, 106, 108, and 110, base station 114 (which may be a cell site or the like), and one or more communication channels 112. The communication channels 112 can communicate over frequency bands assigned to the carrier. In network environment 100, UE devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 600) that communicates via wireless communications with the base station 114 in order to interact with a public or private network.

In some aspects, each of the UEs 102, 104, 106, 108, and 110 may correspond to computing device 600 in FIG. 6. Thus, a UE can include, for example, a display(s), a power source(s) (e.g., a battery), a data store(s), a speaker(s), memory, a buffer(s), a radio(s) and the like. In some implementations, for example, devices such the UEs 102, 104,106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through base station 114. Base station 114 may be a gNodeB in a 5G or 6G network.

The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects sub scribers to their immediate telecommunications service provider (i.e., home network carrier). In some instances, the one or more communication channels 112 can be associated with a telecommunications provider that provides services (e.g., 3G network, 4G network, LTE network, 5G network, and the like) to user devices, such as UEs 102, 104, 106, 108, and 110. For example, the one or more communication channels may provide voice, SMS, and/or data services to UEs 102. 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network or a 6G network.

In some implementations, base station 114 is configured to communicate with a UE, such as UEs 102, 104, 106, 108, and 110, that are located within the geographic area, or cell, covered by radio antennas of base station 114. Base station 114 may include one or more base stations, base transmitter stations, radios, antennas, antenna arrays, power amplifiers, transmitters/receivers, digital signal processors, control electronics, GPS equipment, and the like. In particular, base station 114 may selectively communicate with the user devices using dynamic beamforming.

As shown, base station 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the base station 114. Base station 114 may store the data communicated by the UEs 102, 104, 106, 108, and 110 at a network database 120. Alternatively, the base station 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the base station 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132, a paging aggregation engine 134, and a scheduler 136. All determinations, calculations, and data further generated by the paging aggregation engine 134 and scheduler 136 may be stored at the memory 132 and also at the data store 142. Although the network component 130 is shown as a single component comprising the memory 132, the paging aggregation engine 134, and the scheduler 136, it is also contemplated that each of the memory 132, paging aggregation engine 134 and scheduler 136 may reside at different locations, be its own separate entity, and the like, within the home network carrier system.

The network component 130 is configured to retrieve signal information, UE device information, latency information, including quality of service (QoS) information, paging aggregation level, and metrics from the base station 114 or one of the UE devices 102, 104, 106, 108, and 110. UE device information can include a device identifier and data usage information. The paging aggregation engine 134 can monitor the paging success rate of the UEs 102, 104, 106, 108, and 110 and determine whether to adjust the paging aggregation level. The scheduler 136 can monitor the activity of the UE devices 102, 104, 106, 108, and 110 as well as the paging aggregation engine 134 for changes in the paging aggregation level. The aggregation engine determines if the paging success rate and/or radio conditions warrant a change in the paging aggregation level. Any changes are communicated to the scheduler 136.

Paging is the way the network notifies UEs that are in idle mode about incoming calls or sessions. Having the paging function optimally configured can improve UE battery life while reducing connection times and minimizing congestion in the network. Improved battery life and reducing congestion also improve the user experience on the network.

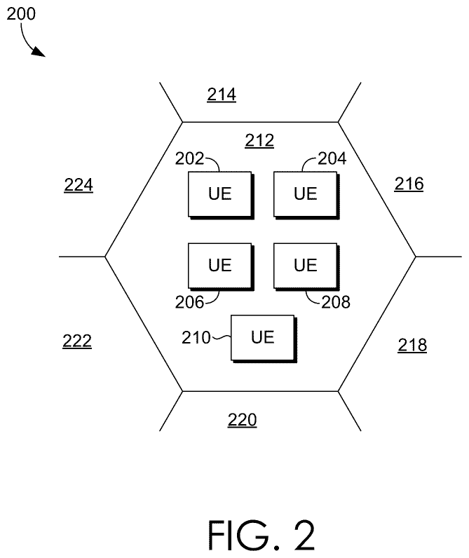

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cells 212, 214, 216, 218, 220, 222, 224, each including base station or base station 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

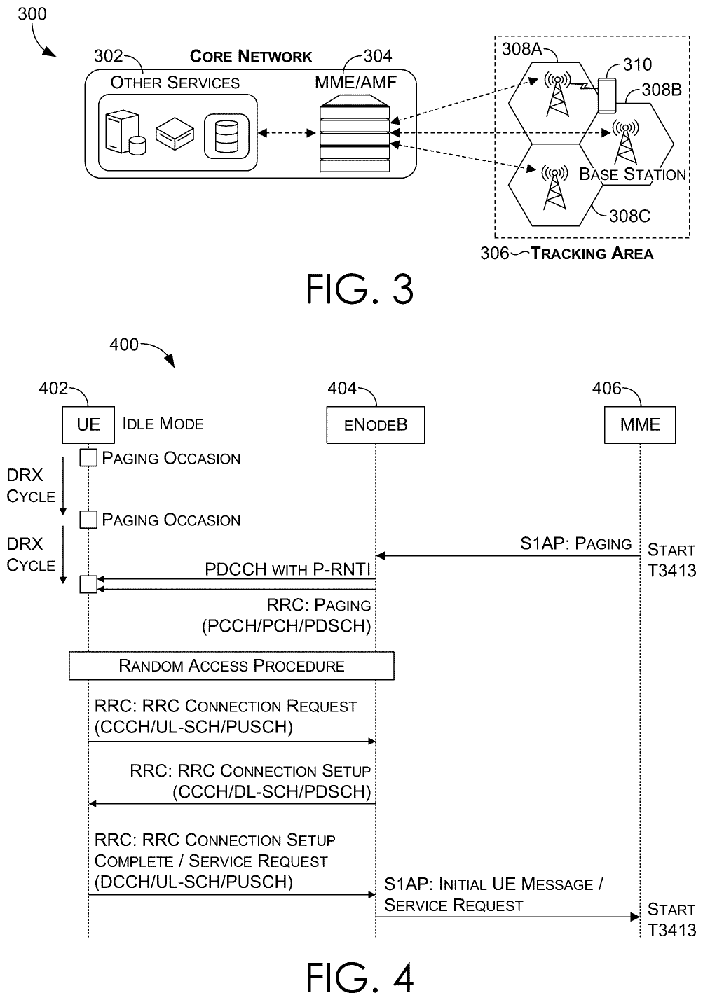

FIG. 3 depicts a diagram of an exemplary network environment incorporating subscriber level paging, in which implementations of the present disclosure may be employed, in accordance with aspects herein. The network 300 includes core network 302 and a tracking area 306. The core network 302 includes other services and a mobility management entity (MME) or an access and mobility management function (AMF) 304. The MME/AMF 304 is a control plane function that can perform the following functions: registration management, reachability management, connection management, and mobility management.

The MME/AMF 304 sends a S1AP paging message to targeted eNBs, such as the eNBs 308 A, 308 B, and 308 C. The eNBs 308 A, 308 B, and 308 C then send a radio resource control (RRC). The S1AP paging message is sent to each eNB with cells belonging to the relevant tracking area 306. Each UE monitors the physical downlink control channel (PDCCH) at regular intervals while in idle mode to check for the presence of the paging message. PDCCH aggregation levels may include levels 1, 2, 4, and 8 with selection of a paging aggregation level based on a tradeoff between robustness and capacity.

Lower PDCCH aggregation levels, such as 1 and 2 may mitigate capacity issues when heavy paging conditions are present. In contrast, a higher aggregation level such as 4 and 8 may assist UEs in poor radio conditions. In many networks a static default aggregation level is set for all UEs in a cell with the result being less than optimal paging success.

The MME/AMF 304 uses the “last known” cell site in the first paging attempt for a UE, such as UE 310 in FIG. 3, for a mobile terminated (MT) session. As illustrated in FIG. 3 UE 310 is moving between eNB 308 A and eNB 308 B. The first paging attempt may use the eNB 308 A in the first paging attempt. If this first attempt fails the MME/AMF 304 then considers the entire tracking area 306 for second and subsequent paging attempts. The “first paging success rate” is measured as successful paging completion on the first paging attempt by the MME/AMF 304 that is sent to the last known eNB.

FIG. 4 is a diagram of paging call flow, in which implementations of the present disclosure may be employed, in accordance with aspects herein. The call flow 400 begins with a UE 402 in idle mode. The UE 402 monitors for paging occasions and checks to see if the S1AP message. The UE 402 while in idle mode operates in a discontinuous transmission mode, that is, it periodically “wakes up” to check for a paging message. If there are no paging messages for UE 402, it returns to idle mode until the next paging occasion.

The MME 406 sends an S1AP paging message to the eNB 404. The eNB 404 then sends the PDCCH with a paging radio network temporary identifier (P-RNTI) to the UE 402. The RRC paging message may be sent using a paging control channel (PCCH), a paging channel (PCH), or a physical downlink shared channel (PDSCH) may be used. This initiates a random access procedure. The UE 402 responds to the paging message with a RRC connection request to the eNB 404 if the UE 402 is successfully reached. The RRC connection request may be sent to the eNB 404 using the common control channel (CCCH), downlink shared channel (DL-SCH), or PDSCH. In response the eNB 404 sends UE 402 the RRC connection setup on the CCCH, uplink shared channel (UL-SCH), or physical uplink shared channel (PUSCH). The eNB 404 sends the MME 406 the initial UE message service request.

FIG. 4 illustrates a successful paging attempt, however, not all paging attempts succeed. Aspects discussed below provide improved paging success rate through the use of dynamic adjustment of paging aggregation level to improve paging success and reduce attempts. A network operator defines a duration in days and identifies all MT subscribers with a first page rate per cell less than an operator defined threshold. There are two potential reasons for the lack of paging success. The first reason is that the UE may not have optimal paging settings. The second reason is that the UE has moved out of the cell.

All UEs with less than the threshold paging success are then categorized into a network operator service profile identifier (SPID). A network operating may determine paging success thresholds for each tracking area and may adjust the paging success threshold as needed if conditions in the tracking area change. If subsequent paging during the same session is successful for the UE on the same cell non-optimal paging settings are the likely reasons. If the frequency used on the cell in question is low band with a relatively large coverage area then the average active RRC connected users is below an operator defined threshold. In this case, the UE's paging aggregation level is set to the highest level, if not already at the highest paging aggregation level. The number of pages per second is also increased by one step if not already at the maximum number of pages per second. UEs continue monitoring the paging discard rate for an operator defined period of time.

If the frequency used in the cell is not a low band frequency and the coverage of the cell is a relatively small area then if the average active RRC connected users is below an operator defined threshold, then the highest PDCCH aggregation level is selected, if the UE is not already at the highest PDCCH aggregation level. UEs may be categorized by the network operator into a “poor paging profile” and proactively moved to low band layers using the SPID. UEs continue monitoring the paging discard rate for an operator defined period of time.

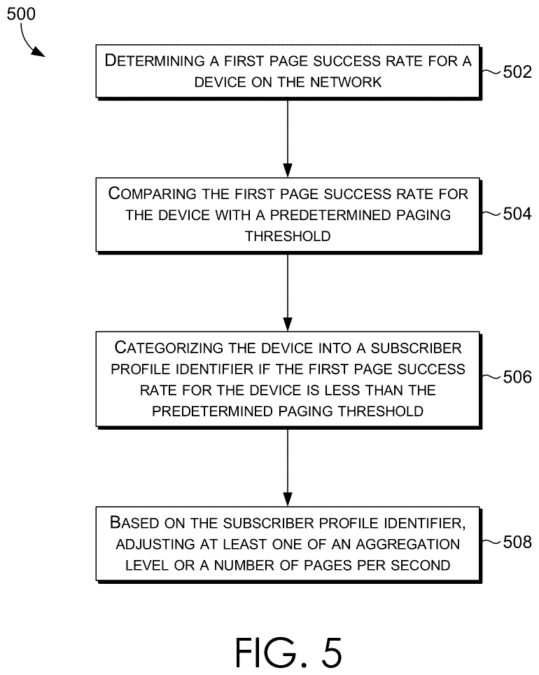

FIG. 5 is a flow diagram of an exemplary method for dynamic adjustment of paging aggregation level, in which aspects of the present disclosure may be employed, in accordance with aspects herein. The method 500 begins with determining a first page success rate for a device on the network in step 502. The first page success rate may be determined for the device in a tracking area of cells, which may a cluster of cells frequented by the device. The method continues in step 504 with comparing the first page success rate for the device with a predetermined paging threshold. The predetermined paging threshold may be determined for a tracking area. The device is then categorized into a subscriber profile identifier if the first page success rate for the device is less than the predetermined paging threshold in step 506. Then, in step 508, based on the subscriber profile identifier, at least one of an aggregation level or a number of pages per second is adjusted.

FIG. 6 depicts an exemplary computing device suitable for use in implementations of the present disclosure, in accordance with aspects herein. With continued reference to FIG. 6, computing device 600 includes bus 602 that directly or indirectly couples the following devices: memory 604, one or more processors 606, one or more presentation components 608, input/output (I/O) ports 612, I/O components 610, radio 616, transmitter 618, and power supply 614. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component such as a display device to be one of I/O components 610. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 604 includes computer-storage media in the form of volatile and/or nonvolatile memory. Memory 604 may be removable, nonremovable, or a combination thereof. Exemplary memory includes solid-state memory, hard drives, optical-disc drives, etc. Computing device 600 includes one or more processors 506 that read data from various entities such as bus 602, memory 604 or I/O components 610. One or more presentation components 608 present data indications to a person or other device. Exemplary one or more presentation components 608 include a display device, speaker, printing component, vibrating component, etc. I/O ports 612 allow computing device 600 to be logically coupled to other devices including I/O components 610, some of which may be built into computing device 600. Illustrative I/O components 610 include a microphone, joystick, game pad, satellite dish, scanner, printer, wireless device, etc.

The radio 616 represents one or more radios that facilitate communication with a wireless telecommunications network. While a single radio 616 is shown in FIG. 6, it is contemplated that there may be more than one radio 616 coupled to the bus 602. In aspects, the radio 616 utilizes a transmitter 618 to communicate with the wireless telecommunications network. It is expressly conceived that a computing device with more than one radio 616 could facilitate communication with the wireless telecommunications network via both the first transmitter 618 and an additional transmitters (e.g. a second transmitter). Illustrative wireless telecommunications technologies include CDMA, GPRS, TDMA, GSM, and the like. The radio 616 may additionally or alternatively facilitate other types of wireless communications including Wi-Fi, WiMAX, LTE, 3G, 4G, LTE, 5G, NR, VoLTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even base stations (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for dynamically adjusting paging settings in a network, the method comprising:
determining a first page success rate for a device on the network;
comparing the first page success rate for the device with a predetermined paging threshold;
categorizing the device into a subscriber profile identifier if the first page success rate for the device is less than the predetermined paging threshold; and
based on the subscriber profile identifier, adjusting at least one of an aggregation level or a number of pages per second.

2. The method of claim 1, further comprising determining if subsequent paging of the device in a same session in a same cell is successful.

3. The method of claim 2, further comprising determining whether a frequency used by the device is a low-band frequency or a non-low-band frequency.

4. The method of claim 3, further comprising, based on the determining the frequency used by the device is a low-band frequency, determining if a number of average active radio resource control (RRC) users is below a defined threshold.

5. The method of claim 4, further comprising if the number of average active RRC users is below the defined threshold, adjusting a physical downlink control channel (PDCCH) aggregation level to a highest aggregation level if not already at the highest aggregation level.

6. The method of claim 4, further comprising increasing the number of pages per second by one step if the number of pages per second is not at a maximum number of pages per second.

7. The method of claim 3, further comprising, based on the determining the frequency used by the device is a non-low-band frequency, determining if a number of average active radio resource control (RRC) users is below a defined threshold.

8. The method of claim 7, further comprising if the number of average active RRC users of the non-low-band frequency is below the defined threshold, adjusting a physical downlink shared channel (PDCCH) to a highest aggregation level if not already at the highest aggregation level.

9. The method of claim 8, further comprising categorizing the device into a poor paging profile if the first paging success rate for the device does not improve when the PDCCH aggregation level is at the highest aggregation level.

10. The method of claim 9, further comprising moving the device into a low-band layer of the network using a subscriber profile identifier.

11. The method of claim 10, further comprising monitoring a paging discard rate for a predefined time.

12. The method of claim 1, wherein the paging success rate threshold is 50 percent or less.

13. A method for dynamically adjusting paging settings in a network, comprising:
determining a paging success threshold for a tracking area of the network;
comparing a first paging success rate for a device on the network with the paging success threshold; and
based on the comparison, increasing an aggregation level of the physical downlink control channel (PDCCH) of the device if the first paging success rate for the device is less than the paging success threshold.

14. The method of claim 13, wherein the paging success threshold for the tracking area is 50 percent or less.

15. The method of claim 13, further comprising increasing a number of pages per second by one step if not at maximum level.

16. The method of claim 13, further comprising determining if the device is on a low-band frequency or a non-low-band frequency.

17. The method of claim 16, further comprising, based on the determining, moving the device from a non-low-band frequency to a low-band frequency.

18. A non-transitory computer storage media storing computer-useable instructions that, when used by one or more processors, cause the processors to:
determine a first page success rate for a device on the network;
compare the first page success rate for the device with a predetermined paging threshold for a tracking area of the network;
categorize the device into a subscriber profile identifier if the first page success rate for the device is less than the predetermined paging threshold; and
based on the subscriber profile identifier, adjust at least one of an aggregation level or a number of pages per second.

19. The non-transitory computer storage media of claim 17, wherein the predetermined paging threshold for the tracking area is 50 percent or less.

20. The non-transitory computer storage media of claim 17, further comprising determining if subsequent paging of the device in a same session in a same cell is successful.
